(19) United States
(12) Patent Application Publication
(10) Pub. No.: US 2013/0266018 A1
(43) Pub. Date: Oct. 10, 2013

(54) COMMUNICATION SYSTEM AND COMMUNICATION METHOD

(71) Applicants: Yuta Ashida, Tokyo (JP); Toshio Koide, Tokyo (JP)

(72) Inventors: Yuta Ashida, Tokyo (JP); Toshio Koide, Tokyo (JP)

(21) Appl. No.: 13/997,158

(22) PCT Filed: Aug. 30, 2011
(86) PCT No.: PCT/JP2011/004815

§ 371 Date: Jun. 21, 2013

(30) Foreign Application Priority Data
Dec. 27, 2010 (JP) 2010-290037

(51) Int. Cl. H04L 12/56

(52) U.S. Cl. CPC H04L 45/745
USPC 370/392

(57) ABSTRACT

A communication system includes a first switch that refers to a first processing rule included in a packet and processes the packet in accordance with the first processing rule; a second switch that includes a table associating and storing an identifier and a second processing rule for a packet, refers to an identifier included in a packet, and processes the packet in accordance with a second processing rule associated with the identifier; and a control apparatus that stores the first processing rule and the identifier in a packet, associates and stores, in the table of the second switch, the identifier and the second processing rule.

### REFERENCE TO RELATED APPLICATION

This application is based upon and claims the benefit of the priority of Japanese patent application No. 2010-290037, filed on Dec. 27, 2010, the disclosure of which is incorporated herein in its entirety by reference thereto. The present invention relates to a communication system and a communication method. In particular, it relates to a communication system and a communication method which realize a communication by means of packet forwarding via a plurality of switches arranged on a network.

### BACKGROUND ART

Non-Patent Literatures 1 and 2 describe OpenFlow, in which communication is deemed as an end-to-end flow, and a routing control, a failure recovery, a load distribution and an optimization are executed for each flow. An OpenFlow switch, which functions as a packet forwarding switch, includes a secure channel for communication with an OpenFlow controller, and operates according to a flow table appropriately added or rewritten by instructions of the OpenFlow controller. In the flow table, a group of: matching rules matched agaist packet headers (FlowKey; matching key); actions defining processing contents (Actions); and flow statistics information (Stats) is defined for each flow.

FIG. 11 shows an example of action names and action contents defined in Non-Patent Literature 2. OUTPUT is an action outputting a packet to a specified port (interface). SET_VLAN_VID to SET_TP_DST are actions modifying packet header fields.

For example, upon receiving a first packet, the OpenFlow switch searches the flow table for an entry having matching rules (FlowKey) that match the header information of the received packet. As a result of the search, if an entry that matches the received packet is found, the OpenFlow switch executes processing contents described in action fields of the entry for the received packet. On the other hand, as a result of the search, if no entry that matches the received packet is found, the OpenFlow switch forwards the received packet to the OpenFlow controller via the secure channel, and requests the OpenFlow controller to determine a path for the packet based on the source and destination of the received packet. Upon receiving a flow entry realizing the path, the OpenFlow switch updates the flow table.

In this way, in OpenFlow, it is necessary that the OpenFlow switch requests the OpenFlow controller to determine a path and output a flow entry to update the flow table. Therefore, a communication delay is caused due to the update of the flow table. In order to solve the problem, Non-Patent Literature 3 describes a method in which a list of processing to be executed in each OpenFlow switch is described in header portion of the packet instead of defining an entry, for each flow, in a flow table normally provided in an OpenFlow switch.

FIG. 12 illustrates an example of a flow table defined in Non-Patent Literature 3. With reference to FIG. 12, for each OpenFlow switch, actions that may be executed by the switch are defined, and an address is given to each of the actions. According to an array of OpenFlow switches via which the packet passes, an array of pointers indicating an address of action executed in each OpenFlow switch is embedded in the packet header. Each OpenFlow switch reads in order an array of pointers in the packet header, and forwards the packet by calling an action to be executed by each switch. In this case, each OpenFlow switch can forward the packet without setting a flow entry for the reception of the packet. Therefore, according to the method described in Non-Patent Literature 3, the delay problem caused due to update of flow table while forwarding can be solved.

### CITATION LIST

### Non Patent Literature

### [NPL 1]

Nick McKeown, and seven others, “OpenFlow: Enabling Innovation in Campus Networks,” [online], [search conducted Dec. 27, 2010] Internet <URL:http://www.OpenFlowswitch.org//documents/OpenFlow-wp-latest.pdf>.

### [NPL 2]

“OpenFlow Switch Specification” Version 1.0.0 (Wire Protocol 0x01) Dec. 27, 2010 Internet <URL: http://www.openflowswitch.org/documents/openflow-spec-v1.0.0.pdf>.

### [NPL 3]

Yasunobu Chiba, and two others, “A Proposal of Flow Entry Reduction Scheme for Flow-based Networks and Its Implementation on OpenFlow-based Network,” IEICE (The Institute of Electronics, Information and Communication Engineers) Technical Report, vol. 109, No. 448, NS2009-163, pp 7-12.

### SUMMARY OF INVENTION

### Technical Problem

The entire disclosures of the above-mentioned Non-Patent Literatures are incorporated herein by reference thereto. The following analyses are given by the present invention.

In the technology described in Non-Patent Literature 3, an array representing actions is embedded in a packet header. In this case, an array of actions that exceeds the packet header length cannot be embedded. Since the length of an array of actions is proportional to the number of switches that exist on a path, if the number of switches becomes large, the length of the array of actions may possibly exceed the packet header length.

If the length of the array of actions exceeds the packet header length, the array of actions needed for the packet forwarding cannot be stored in the packet header. In this case, if the array of actions in the packet header has been read in up to the end in the intermediary of forwarding path of the packet, the switch requests the control apparatus to calculate the rest of the array of actions. A delay and a load are caused in the network due to the request operation for an array of actions by the switches in the intermediary of forwarding path of the packet. Particularly, if a path of the packet forwarding is quite long such as a packet forwarding via wide area network, the request operation for an array of actions by switches often occurs, so that the delay and load are increased.

Therefore, there is a need to reduce the number of processing rules stored in the switches, and in a case where a packet is forwarded in a large-scale network, to reduce requests of a path determination and processing rules from the switches to the control apparatus. It is an object of the present invention to provide a communication system and a communication method that can solve the above-mentioned problem.

### Solution to Problem

According to a first aspect of the present invention, there is provided a communication system, comprising: a first switch that refers to a first processing rule included in a packet and processes the packet in accordance with the first processing rule; a second switch that includes a table associating and storing an identifier and a second processing rule for a packet, refers to an identifier included in a packet, and processes the packet in accordance with a second processing rule associated with the identifier; and a control apparatus that stores the first processing rule and the identifier in a packet, associates and stores, in the table of the second switch, the identifier and the second processing rule.

According to a second aspect of the present invention, there is provided a communication method, comprising: by a first switch, referring to a first processing rule included in a packet and processing the packet in accordance with the first processing rule; by a second switch that includes a table associating and storing an identifier and a second processing rule for a packet, referring to an identifier included in a packet and processing the packet in accordance with a second processing rule associated with the identifier; by a control apparatus, storing the first processing rule and the identifier in a packet; and by the control apparatus, associating and storing, in the table of the second switch, the identifier and the second processing rule.

### Advantageous Effects of Invention

According to the communication system and the communication method according to the present invention, it is possible to reduce the number of the processing rules stored in the switches, and in a case where a packet is forwarded in a large-scale network, to reduce requests of a route determination and processing rules from the switches to the control apparatus.

### BRIEF DESCRIPTION OF DRAWINGS

FIG. 1 is a diagram showing a configuration of a communication system according to a first exemplary embodiment;

FIG. 2 is a block diagram showing a configuration of a switch of the communication system according to the first exemplary embodiment;

FIG. 3 is a block diagram showing a configuration of a control apparatus of the communication system according to the first exemplary embodiment;

FIG. 4 illustrates a manner of packet forwarding in the communication system according to the first exemplary embodiment;

FIG. 5 illustrates a second processing rule set in the switches SW1, SW2 of the communication system according to the first exemplary embodiment;

FIG. 6 illustrates a packet structure of the communication system according to the first exemplary embodiment;

FIG. 7 is a diagram showing a configuration of a communication system according to a second exemplary embodiment;

FIG. 8 is a block diagram showing a configuration of a control apparatus of the communication system according to the second exemplary embodiment;

FIG. 9 illustrates a path tree calculated by the control apparatus of the communication system according to the second exemplary embodiment;

FIG. 10 is a diagram showing a configuration of a communication system according to a third exemplary embodiment;

FIG. 11 illustrates action names and action contents defined in Non-Patent Literature 2; and

FIG. 12 illustrates a flow table defined in Non-Patent Literature 3.

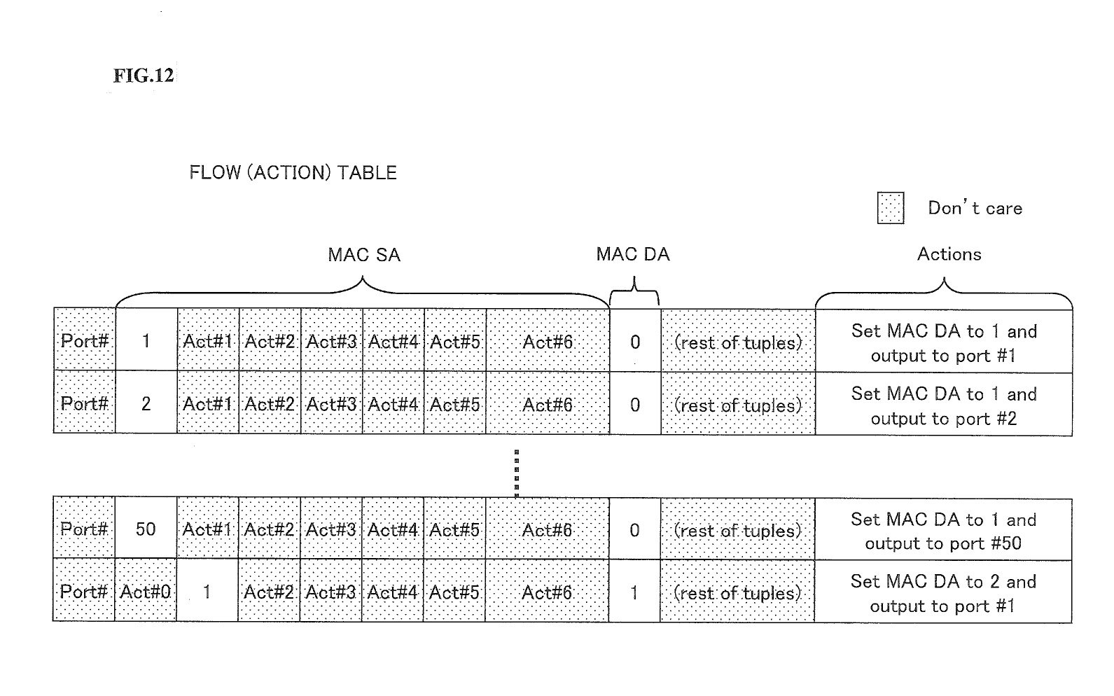

### DESCRIPTION OF EMBODIMENTS

First, an outline of the present invention will be described. Furthermore, drawing reference symbols described in this outline are shown only as examples in order to assist understanding, and are not intended to limit the present invention to the modes shown in the drawings.

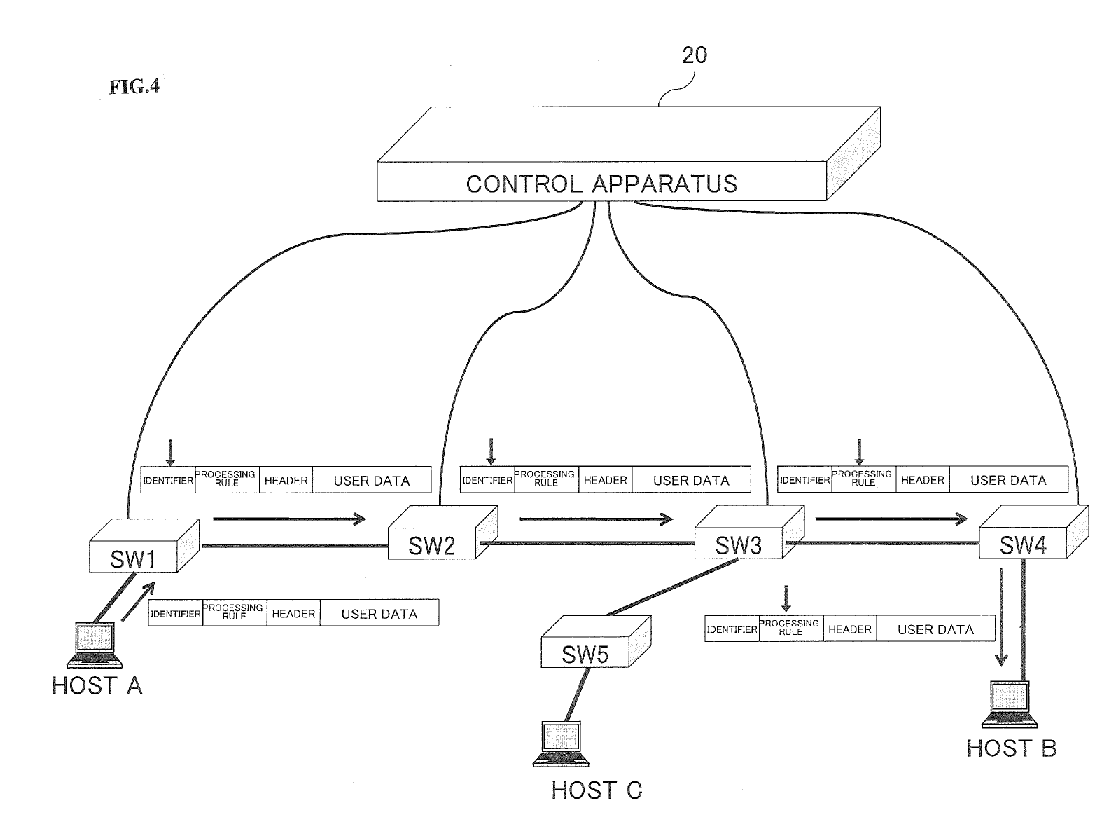

With reference to FIG. 4, a communication system of the present invention comprises: a first switch (SW3, SW4) that refers to a first processing rule included in a packet and processes the packet in accordance with the first processing rule; a second switch (SW1, SW2) that includes a table associating and storing an identifier and a second processing rule for a packet and processes a packet in accordance with a second processing rule associated with an identifier included in the packet; and a control apparatus (20) that stores the first processing rule and the identifier in a packet, associates and stores, in the table of the second switch, the identifier and the second processing rule.

A switch (SW3, SW4) refers to a processing rule corresponding to the switch in an array of processing rules included in a packet, and process the packet according to the processing rule.

A switch (SW3, SW4) may refer to a processing rule corresponding to the switch by using a pointer that specifies a processing content set in the switch.

Furthermore, if an identifier is included in processing rules and corresponds to the switch itself, the switch (SW1, SW2) refers to a content set in the processing rule storage unit of the switch itself, and executes a processing content (packet rewriting, packet forwarding, and packet dropping or the like) specified in a second processing rule corresponding to the identifier.

The control apparatus (20) sets a processing rule to be executed based on the identifier as a second processing rule to the processing rule storage unit of the switch (SW1, SW2).

An array of processing rules may be an array of processing rules to be referred by any switches in the communication system. The array of processing rules may include a predetermined identifier other than processing rules. As a method for specifying a processing rule or an identifier to be referred by the switch itself in an array of processing rules, positions of processing rules among the array of processing rules may be assigned to the switches respectively. According to the order of processing rules in the array of processing rules, each switch may extract a processing rule one by one from the beginning or the end. Furthermore, a counter that indicates a portion to be referred by each switch may be set in a packet.

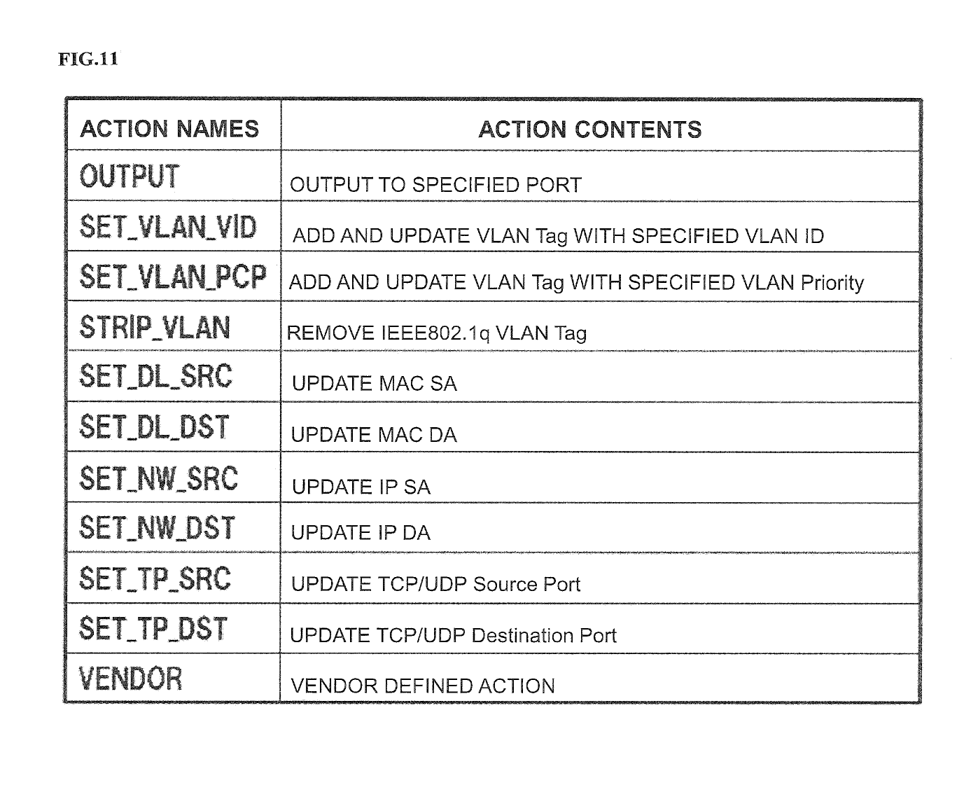

Here, the processing rule and the processing rule storage unit respectively correspond to a flow entry and a flow table in the above-mentioned OpenFlow technology. However, a method for implementing the present invention is not limited to OpenFlow. For example, if the method is a method for searching a processing rule that matches a received packet and executing processing of rewriting the header and outputting the packets from a specified port or the like, the method meets the requirement (refer to FIG. 11, and “3.3 Actions” on pages 4-6, “Table 5” of Non-Patent Literature 2).

As a method for adding an array of processing rules to a packet, the control apparatus (20) may generate a packet including an array of processing rules and forward the packet to a switch (SW1). And the switch (SW1) may forward the packet to the next hop switch (SW2). Furthermore, the switch (SW1) may receive an array of processing rules from the control apparatus (20) and add the array of processing rules to a packet, and forward the packet to the next hop switch (SW2). On the other hand, a dedicated apparatus may be provided that receives necessary processing rules from the control apparatus (20) and generates an array of process rules. A switch disposed in the border with external servers or terminals among switches may receive a plurality of processing rules from the control apparatus (20) and generate an array of processing rules. Meanwhile, deleting the array of processing rules added to the initial packet may be executed by the switch that is a termination switch (SW2).

According to the communication system of the present invention, it is possible to reduce a load of the control apparatus. Because it is possible to reduce the number of arrays of processing rules included in a packet and reduce inquiries to the control apparatus while forwarding by associating an array of processing rules needed for forwarding to a predetermined switch with one identifier.

And according to the communication system of the present invention, it is possible to suppress a delay while communicating. Because it is possible to reduce inquiries to the control apparatus while forwarding a packet.

Furthermore, according to the communication system of the present invention, it is possible to reduce setting processing of processing rules needed for forwarding. Because it is possible to avoid setting processing of processing rules for each flow by associating processing rules needed for forwarding to a predetermined switch with one identifier to be set in the switches of the communication system.

In the present invention, the following modes are possible.

### <Mode 1>

There is provided a communication system according to the above first aspect of the present invention.

### <Mode 2>

In the communication system, the first switch may include a table that associates a pointer and the first processing rule, refer to a pointer included in a packet, and process the packet in accordance with the first processing rule associated with the pointer; and the control apparatus may store the pointer and the identifier in a packet, associate and store, in the table of the first switch, the pointer and the first processing rule.

### <Mode 3>

In the communication system, the control apparatus may store the first processing rule or the pointer, and the identifier in a header field of a packet.

### <Mode 4>

In the communication system, the first switch may refer to a count value included in a packet and, in accordance with the count value, refer to the first processing rule or the pointer included in the packet; and the second switch may refer to a count value included in a packet and, in accordance with the count value, refer to the identifier included in the packet.

### <Mode 5>

In the communication system, the first switch, after updating the count value, may process the packet in accordance with the first processing rule; and the second switch, after updating the count value, may process the packet in accordance with the second processing rule if the second switch is the last switch that refers to the identifier, and otherwise, may process the packet in accordance with the second processing rule without updating the count value.

### <Mode 6>

In the communication system, the second switch may delete the identifier included in the packet or describe in the packet that the identifier has been already referred to if the second switch is the last switch that refers to the identifier.

### <Mode 7>

The communication system may comprise a plurality of the second switches, wherein the control apparatus may determine a path tree for the plurality of second switches and store packet-forwarding based on the determined path tree as the second processing rule in each table of the plurality of second switches.

### <Mode 8>

In the communication system, the control apparatus may select a switch corresponding to a root node of the path tree among the plurality of second switches in accordance with order of connection points for the switch, traffic volume of packets processed by the switch, or number of flows processed by the switch.

### <Mode 9>

There is provided a communication method according to the above second aspect of the present invention.

### <Mode 10>

In the communication method, the first switch may includes a table that associates a pointer and the first processing rule, and the method may comprise: by the first switch, referring to a pointer included in a packet and processing the packet in accordance with the first processing rule associated with the pointer; by the control apparatus, storing the pointer and the identifier in a packet; and by the control apparatus, associating and storing, in the table of the first switch, the pointer and the first processing rule.

### <Mode 11>

In the communication method, the control apparatus may store the first processing rule or the pointer, and the identifier in a header field of a packet.

### <Mode 12>

The communication method may comprise: by the first switch, referring to a count value included in a packet and, in accordance with the count value, referring to the first processing rule or the pointer included in the packet; and by the second switch, referring to a count value included in a packet and, in accordance with the count value, referring to the identifier included in the packet.

### <Mode 13>

The communication method may comprise: by the first switch, after updating the count value, processing the packet in accordance with the first processing rule; and by the second switch, after updating the count value, processing the packet in accordance with the second processing rule if the second switch is the last switch that refers to the identifier, and otherwise, processing the packet in accordance with the second processing rule without updating the count value.

### <Mode 14>

The communication method may comprise: by the second switch, deleting the identifier included in the packet or describing in the packet that the identifier has been already referred to if the second switch is the last switch that refers to the identifier.

### <Mode 15>

The communication method may comprise: by the control apparatus, determining a path tree for a plurality of the second switches; and storing packet-forwarding based on the determined path tree as the second processing rule in each table of the plurality of second switches.

### First Exemplary Embodiment

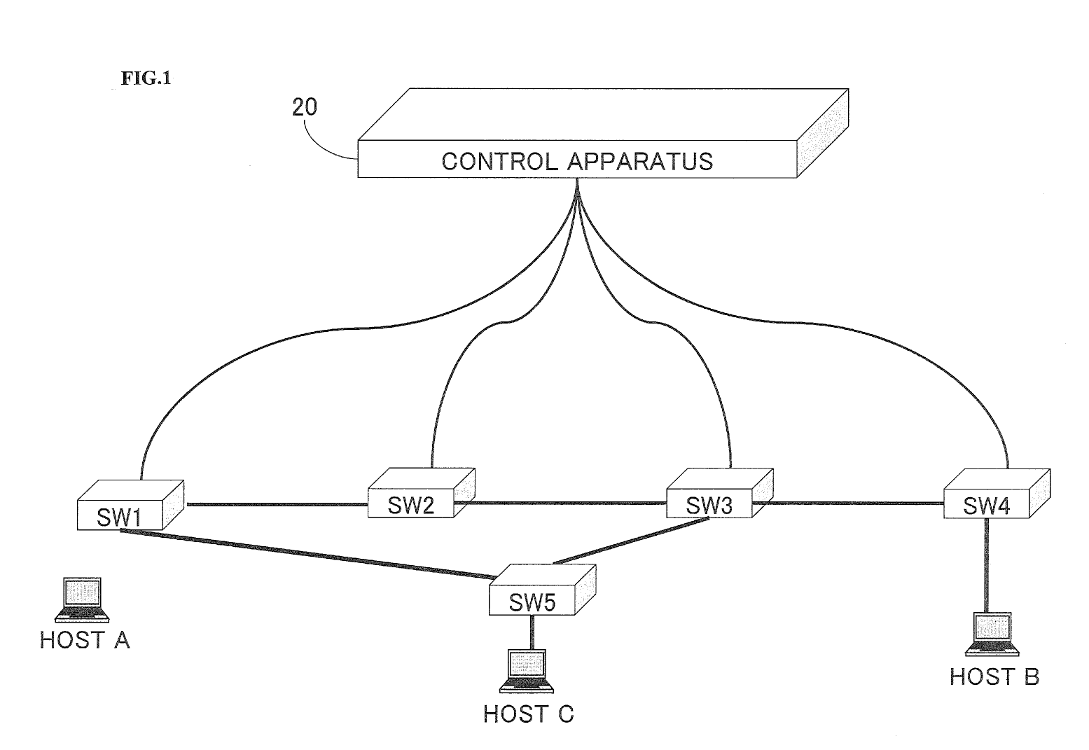

A communication system according to a first exemplary embodiment will be described with reference to the drawings. FIG. 1 is a diagram showing an example of a configuration of a communication system according to the present exemplary embodiment.

With reference to FIG. 1, five switches SW1-SW5, a control apparatus (controller) 20, and hosts A-C that communicate via switches SW1-SW5 are shown. FIG. 1 shows five switches SW1-SW5, the control apparatus (controller) 20, and three hosts A-C as an example. However, the number of these apparatus included in the communication system is not limited to the mode shown in FIG. 1.

Each of the switches SW1-SW5 refers to a first rule for a packet processing to be executed by the switch in an array of processing rules included in a packet, and processes the packet according to the first rule. If the packet includes a predetermined identifier, each of the switches SW1-SW5 receives a packet processing to be executed by the switch and the identifier from the control apparatus or the like, and stores the packet processing and the identifier as a second processing rule to the processing rule storage unit (for example, a flow table in OpenFlow).

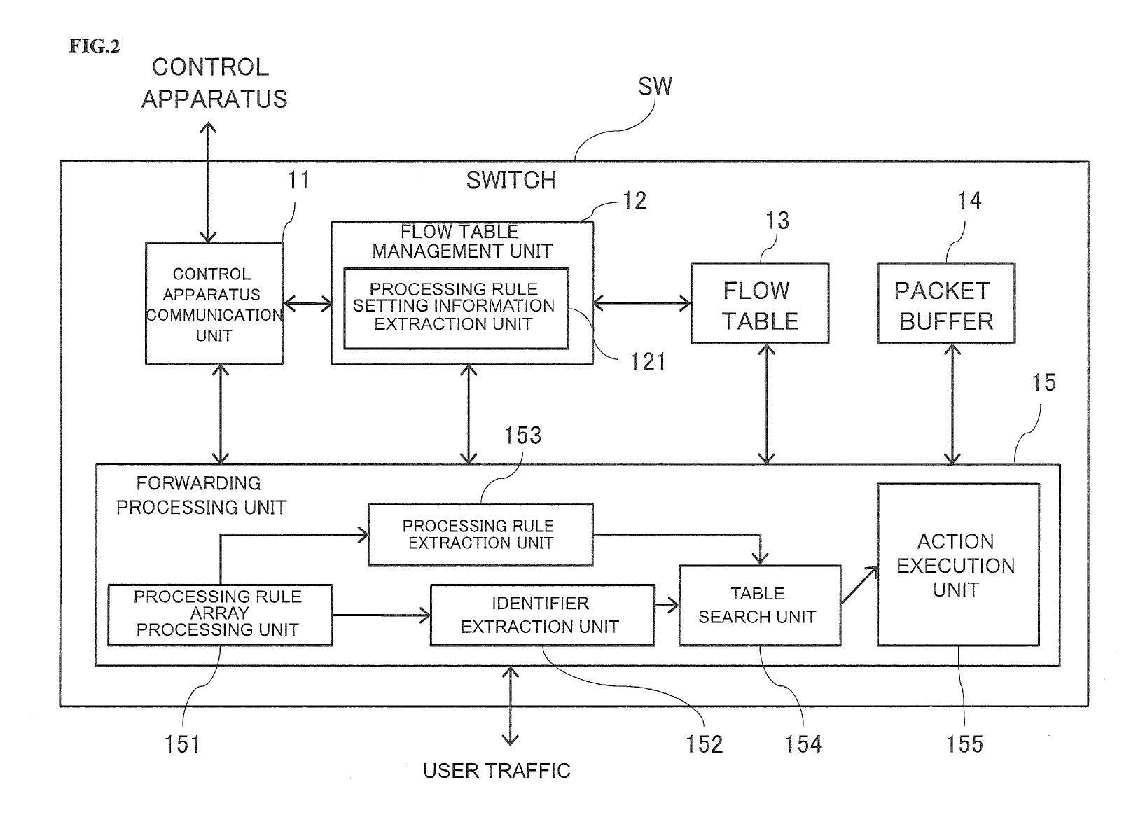

FIG. 2 is a block diagram showing a detailed configuration of each of the switches SW1-SW5. With reference to FIG. 2, each of the switches SW1-SW5 includes: a control apparatus communication unit 11 that communicates with control apparatus 20; a flow table 13; a flow table management unit 12 that manages the flow table 13; and a forwarding processing unit 15. Each of the switches SW1-SW5 may further include a packet buffer 14.

The flow table management unit 12 includes a processing rule setting information extraction unit 121 that extracts a second processing rule to be set to the own switch based on a processing rule setting message received from the control apparatus.

The forwarding processing unit 15 includes a processing rule array processing unit 151, an identifier extraction unit 152, a processing rule extraction unit 153, a table search unit 154, and an action execution unit 155.

The processing rule array processing unit 151 acquires an array of processing rules included in a packet, and extracts a processing rule to be referred to by the own switch. If the processing rule is a predetermined identifier, the processing rule is transferred to the identifier extraction unit 152, and otherwise, the processing rule is transferred to the processing rule extraction unit 153. The identifier extraction unit 152 outputs a search instruction of the second processing rule based on the identifier transferred by the processing rule array processing unit 151. The processing rule extraction unit 153 outputs a processing rule transferred by the processing rule array processing unit 151 to the table search unit 154. The table search unit 154 searches the corresponding first processing rule or second processing rule based on the output from the identifier extraction unit 152 or the processing rule extraction unit 153, and outputs the specified processing content to the action execution unit 155. The action execution unit 155 executes a processing content outputted from the table search unit 154. As the result of the searching in the flow table 13, if no processing rule that matches the received packet is found, the table search unit 154 buffers the received packet to the packet buffer 14 and requests the control apparatus 20 to generate a processing rule.

The switches SW1-SW5 can be also realized by adding the processing rule setting information extraction unit 121, the processing rule array processing unit 151, the identifier extraction unit 152 and processing rule extraction unit 153 to OpenFlow switches as an example.

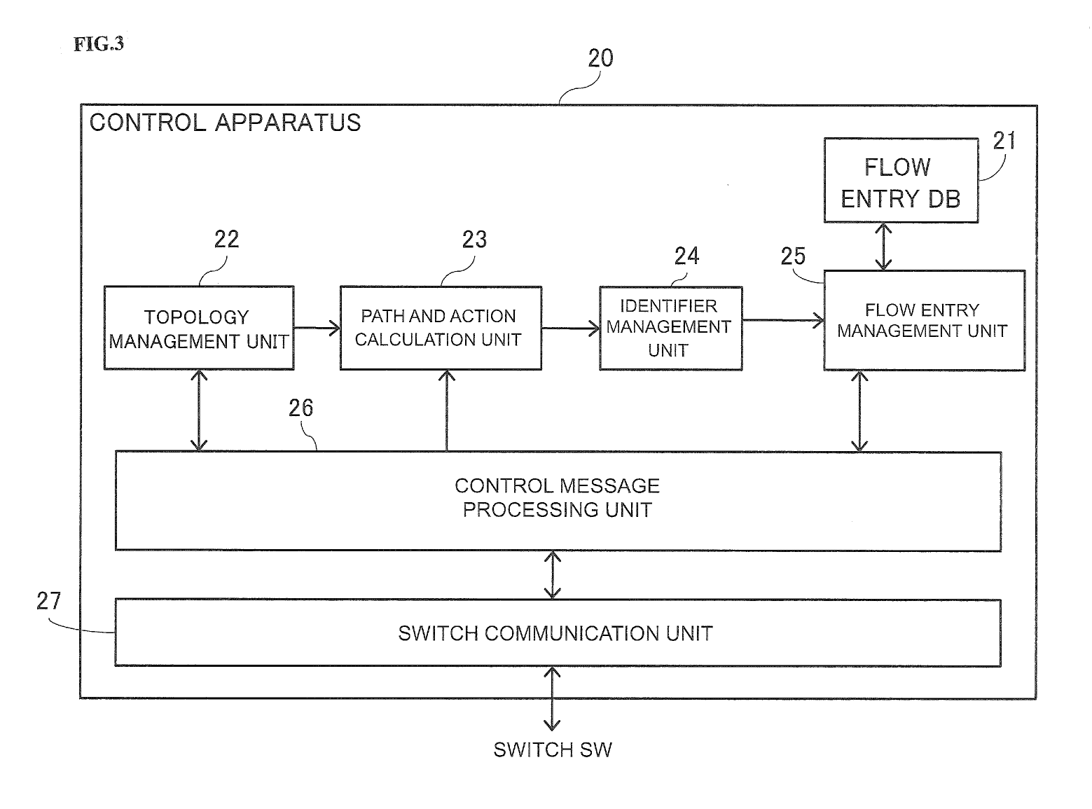

FIG. 3 is a block diagram showing an example of a configuration of the control apparatus 20. With reference to FIG. 3, the control apparatus 20 includes a flow entry DB21, a topology management unit 22, a path and action calculation unit 23, an identifier management unit 24, a flow entry management unit 25, a control message processing unit 26 and a switch communication unit 27.

The flow entry DB21 stores processing rules (flow entries) set in the switches SW1-SW5. The path and action calculation unit 23 calculates a path needed for forwarding a packet and processing to be executed by each switch in order to forward the packet via the path. The identifier management unit 24 assigns an identifier to processing contents calculated by the path and action calculation unit 23. The flow entry management unit 25 generates the identifier and the processing contents associated by the identifier management unit 24 as a second processing rule. The control message processing unit 26 converts control contents for the switches SW1-SW5 to control messages, or analyzes and processes the control message from the switches SW1-SW5. The switch communication unit 27 communicates with the switches SW1-SW5.

Next, an operation of the communication system of the present exemplary embodiment will be described on the basis of a specific example. FIG. 4 schematically illustrates a manner in which a packet including a first processing rule and an identifier is forwarded. Here, second processing rules, on which a packet including a predetermined identifier is forwarded from the switch SW1 to the switch SW3, are set in the switches SW1, SW2 before the packet-forwarding.

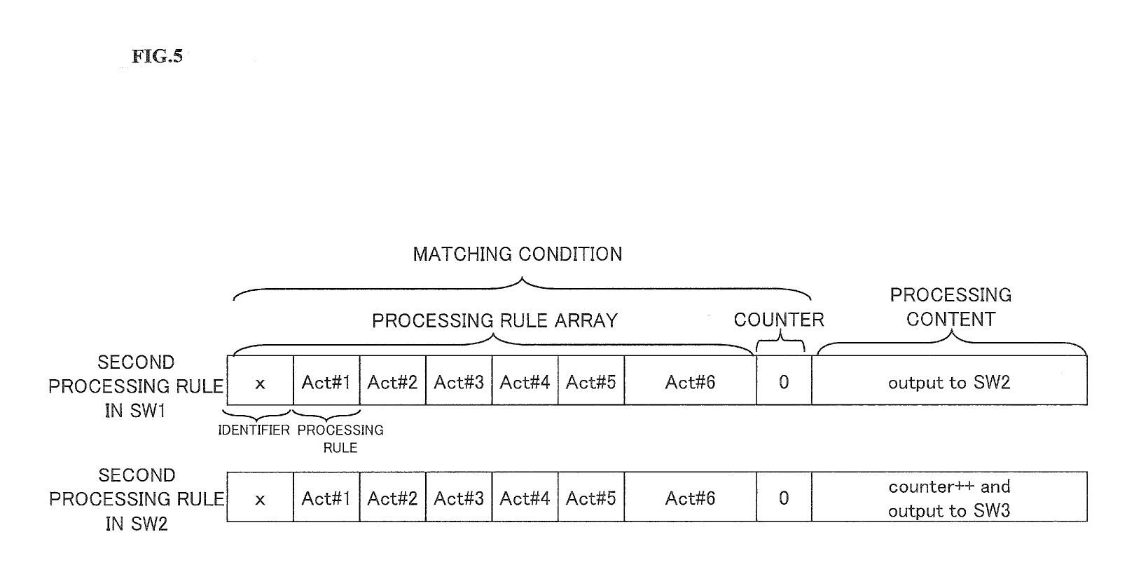

FIG. 5 illustrates the second processing rules set in the switches SW1, SW2. The number of processing rules included in an array of processing rules shown in FIG. 5 is merely an illustration. Namely, it is possible to include arbitrary number of processing rules in an array of processing rules.

An array of processing rules in the packet includes processing rules and an identifier which are put in the order of the switches to be referred to. A counter may be set up in a packet in order to discriminate a portion of the packet to be referred by each switch.

A matching condition shown in FIG. 5 is used to search a processing rule that matches the packet. If a processing rule of a portion specified by the counter matches a processing rule of a portion to be referred to in the packet, the switch processes the packet according to the processing rule.

The counter in the packet indicates what order of processing rule of the array of processing rules should be referred to by each switch. After a reference to the processing rule or the identifier is completed, the switch increments the count value of the counter in the packet.

In the present exemplary embodiment, a case, where a counter is used to specify a portion to be referred to, is described. On the other hand, if processing rules and an identifier in a packet are arrayed in the order of the switches to be referred to, a switch that refers lastly to the processing rule or the identifier may delete the referred processing rule or identifier from the packet. And the switch that refers lastly to the processing rule or the identifier may describe in the packet that the referred processing rule or identifier has been already referred to.

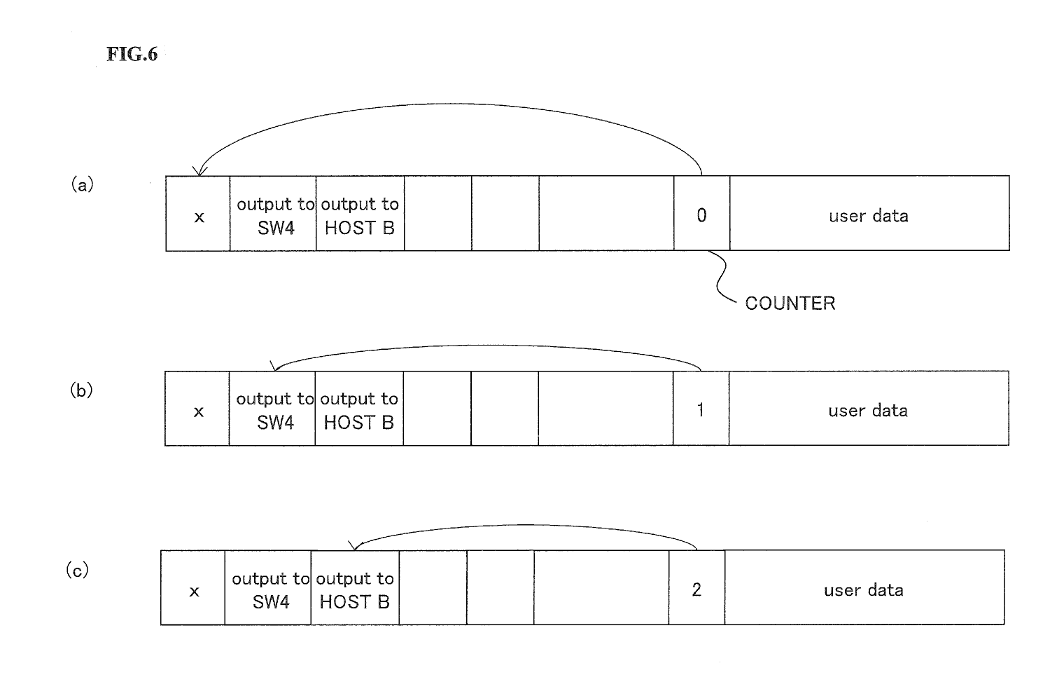

Next, an operation of the communication system of the present exemplary embodiment will be described. Here, it is assumed that a packet including an identifier x and first processing rules that specify processing in the switches SW3, SW4 is transmitted from host A. As an example, it is considered that host A sends a packet having a structure shown in FIG. 6(a).

The switch SW1 applies a second processing rule corresponding to the identifier x, and forwards the packet to the switch SW2. Since the switch SW1 is not a switch that refers lastly to the identifier x, the switch SW1 does not increment the count value of the counter. Therefore, a structure of the packet that is forwarded from the switch SW1 to the switch SW2 is still the same as in FIG. 6(a).

Next, the switch SW2 applies a second processing rule corresponding to the identifier x in the same way as the switch SW1. The switch SW2 is a switch that refers lastly to the identifier x. Therefore, with reference to FIG. 5, a second processing rule set in the switch SW2 corresponding to the identifier x is different from the rule set in the switch SW1 in that an increment of the count value of the counter included in the packet (“counter++”) is specified. And a packet forwarding to the switch SW3 (“output to SW3”) is also specified simultaneously in the processing rule of the identifier x set in the switch SW2. Therefore, after the switch SW2 increments the count value of the counter, the switch SW2 forwards the packet to the switch SW3. FIG. 6(b) shows a structure of the packet that is forwarded from the switch SW2 to the switch SW3. With reference to FIG. 6(b), the count value of the counter is incremented to be “1.”

If the switch SW3 receives the packet shown in FIG. 6(b), the switch SW3 refers to a first processing rule “output to SW4” described in the second portion of the packet based on the count value “1” of the counter. Therefore, after the switch SW3 increments the count value of the packet, the switch SW3 forwards the packet to the switch SW4. FIG. 6(c) shows a structure of the packet that is forwarded from the switch SW3 to the switch SW4. With reference to FIG. 6(c), the count value of the counter is incremented to be “2.”

If the switch SW4 receives the packet shown in FIG. 6(c), the switch SW4 refers to a first processing rule “output to host B” described in the third portion of the packet based on the count value “2” of the counter, and forwards the packet to host B according to the processing rule.

By the above-mentioned operations, the packet forwarding from host A to host B has completed.

By the way, in the first processing rules included in the packet in FIGS. 6(a) to 6(c), if “output to SW4” is replaced with “output to SW5,” and “output to host B” is replaced with “output to host C,” the packet is transferred from host A to host C.

In the present exemplary embodiment, switches, in which second processing rules corresponding to an identifier are set, can be selected arbitrarily. And the switches, in which second processing rules are set, can be changed as needed.

Furthermore, the order, in which an identifier and first processing rules are included in the packet, is also arbitrary. Therefore, after a packet is forwarded according to a first processing rule, at the time point that the packet arrives at a switch in which a second processing rule is set, the packet may be forwarded according to the second processing rule.

In the present exemplary embodiment, a case where an array of processing rules is included in the packet transmitted from host A is described. However, a switch may embed the array of processing rules in the packet.

If the packet communication from host A to host B is executed according to only first processing rules, processing of all switches through which the packet passes must be included in the packet. In this case, the number of processing rules that must be included in the packet is four: “output to SW2,” “output to SW3,” “output to SW4” and “output to host B.”

On the other hand, with reference to FIG. 6, if an identifier x is used as shown in the communication system of the present exemplary embodiment, the number of the identifier and processing rules included in the packet is three. Therefore, according to the communication system of the present exemplary embodiment, it is possible to make the packet size smaller than that in the case where the packet is forwarded according to only first processing rules.

Besides, according to the communication system of the present exemplary embodiment, even in a case where a size of an array of processing rules exceeds a size capable of being included in the packet, it is possible to avoid inquiries from the switches to the control apparatus 20 by setting part of processing rules as first processing rules, and setting the rest as second processing rules. Namely, according to the communication system of the present exemplary embodiment, even in a case where a long path is formed by a group of switches so that the length of the array of actions exceeds a packet header length, the switches can forward the packet without inquiring to the control apparatus by setting second processing rules to the switches.

### Second Exemplary Embodiment

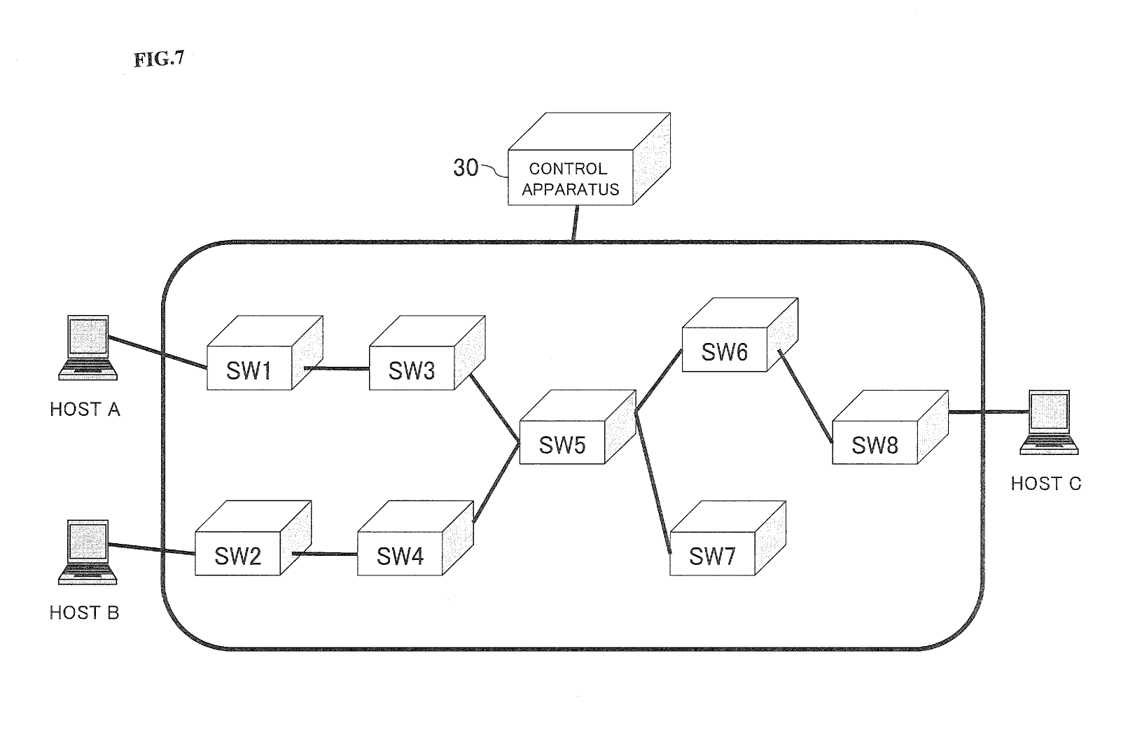

A communication system according to a second exemplary embodiment will be described with reference to the drawings. The communication system according to the present exemplary embodiment includes a plurality of switches, among which a hub switch connected to the other plurality of switches is included. FIG. 7 is a block diagram showing a configuration of a communication system according to the present exemplary embodiment.

With reference to FIG. 7, the communication system according to the present exemplary embodiment includes a control apparatus 30 and eight switches SW1-SW8. Hosts A-C communicate via the switches SW1-SW8. The switch SW5 is a hub switch connected to a plurality of switches (four switches SW3, SW4, SW6 and SW7 in FIG. 7). Although FIG. 7 is illustrated in a simplified manner, the control apparatus 30 is connected to all the switches SW1-SW8.

FIG. 7 illustrates the control apparatus 20, eight switches SW1-SW8, and three hosts A-C as an example. Only the switch SW5 is a hub switch. However, the number of these apparatuses included in the communication system is not limited to the mode shown in FIG. 7.

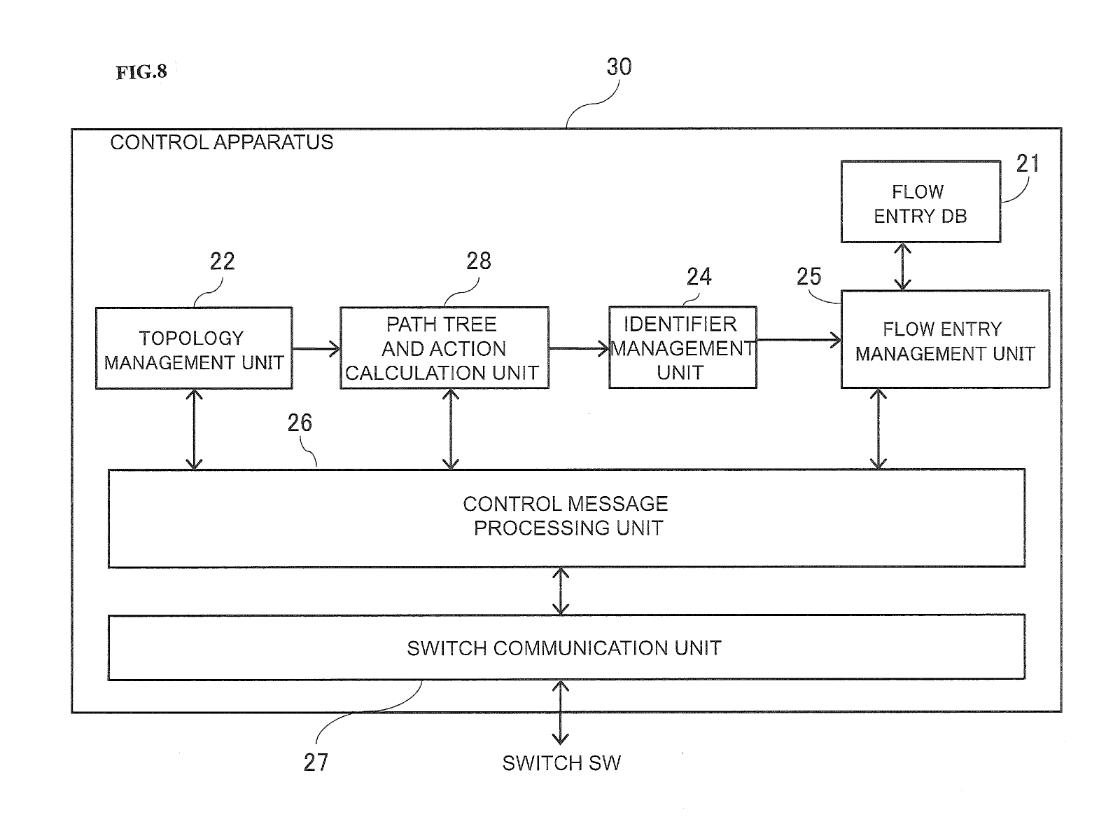

FIG. 8 is a block diagram showing an example of a configuration of the control apparatus 30 according to the present exemplary embodiment. With reference to FIG. 8, the control apparatus 30 includes a flow entry DB 21, a topology management unit 22, a path tree and action calculation unit 28, an identifier management unit 24, a flow entry management unit 25, a control message processing unit 26 and a switch communication unit 27.

The flow entry DB21 stores processing rules (flow entries) that are set in the switches SW1-SW8. The path tree/action calculation unit 28 calculates a path tree in which a hub switch is set as a root, and also calculates processing to be executed by each switch in order to forward a packet via the path. The identifier management unit 24 assigns an identifier to processing contents calculated by the path tree and action calculation unit 28. The flow entry management unit 25 generates the identifier and the processing contents associated by the identifier management unit 24 as second processing rules. The control message processing unit 26 converts control contents for the switches SW1-SW8 to control messages, or analyzes and processes the control messages from the switches SW1-SW8. The switch communication unit 27 communicates with the switches SW1-SW8.

The control apparatus 30 executes the following processing in order to reduce the number of processing rules included in an array of processing rules needed for a packet forwarding.

First, the topology management unit 22 searches and selects a hub switch in the network. Order (or number) of connection points of a switch may be used as an evaluation criterion to select the hub switch. And traffic volume or number of flows that a switch processes may be adopted as the evaluation criterion.

The path tree and action calculation unit 28 calculates a path tree, in which the hub switch is set as a root, based on the hub switch selected by the topology management unit 22, and calculates processing contents needed for each switch in a case where the packet is forwarded via the calculated path tree.

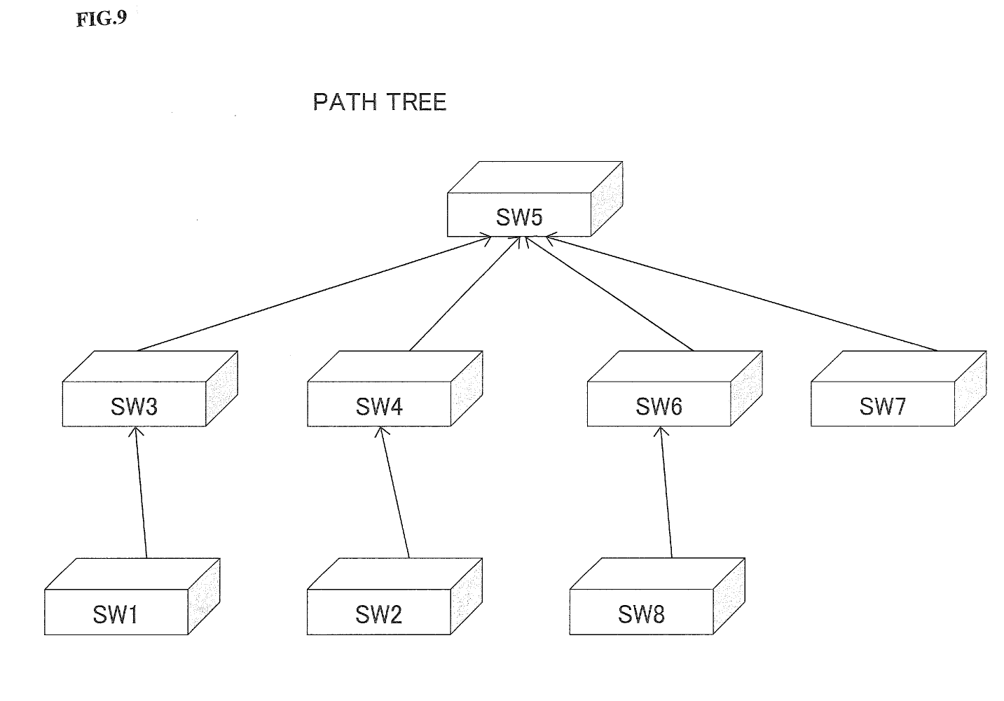

FIG. 9 illustrates an example of a path tree calculated by the path tree and action calculation unit 28. The path tree and action calculation unit 28 may calculate a path tree by using Dijkstra's Algorithm in which the number of hops is used as a metric. And the path tree and action calculation unit 28 may adopt a path tree by the other metrics and algorithms.

The identifier management unit 24 assigns a unique identifier to the path tree and the processing contents according to the path tree. In this way, second processing rules that are set in each switch can be obtained. The second processing rules and identifier are set in the switches SW1-SW8.

The control apparatus 30 executes the above-mentioned processing before a packet forwarding. In this case, a packet(s) can be forwarded from a switch(es), in which a set of the second processing rules are set, to the hub switch SW5 using one identifier. Further, it is sufficient that one set of second processing rules is set in each switch.

On the other hand, if second processing rules needed for forwarding from all switches in the communication network to the hub switch SW5 are set based on a path instead of the path tree, each individual processing rule must be assigned to each of the paths, so that the same number of processing rules as the number of the paths are set to switches used for a plurality of paths.

The number of arrays of processing rules included in a packet can be reduced to half at a maximum by setting the second processing rules relating to the forwarding to the hub switch in all switches of the communication network. Therefore, according to the communication system according to the present exemplary embodiment, the number of hops of packet forwarding without inquiring to the control apparatus 30 during the forwarding can be increased.

### Third Exemplary Embodiment

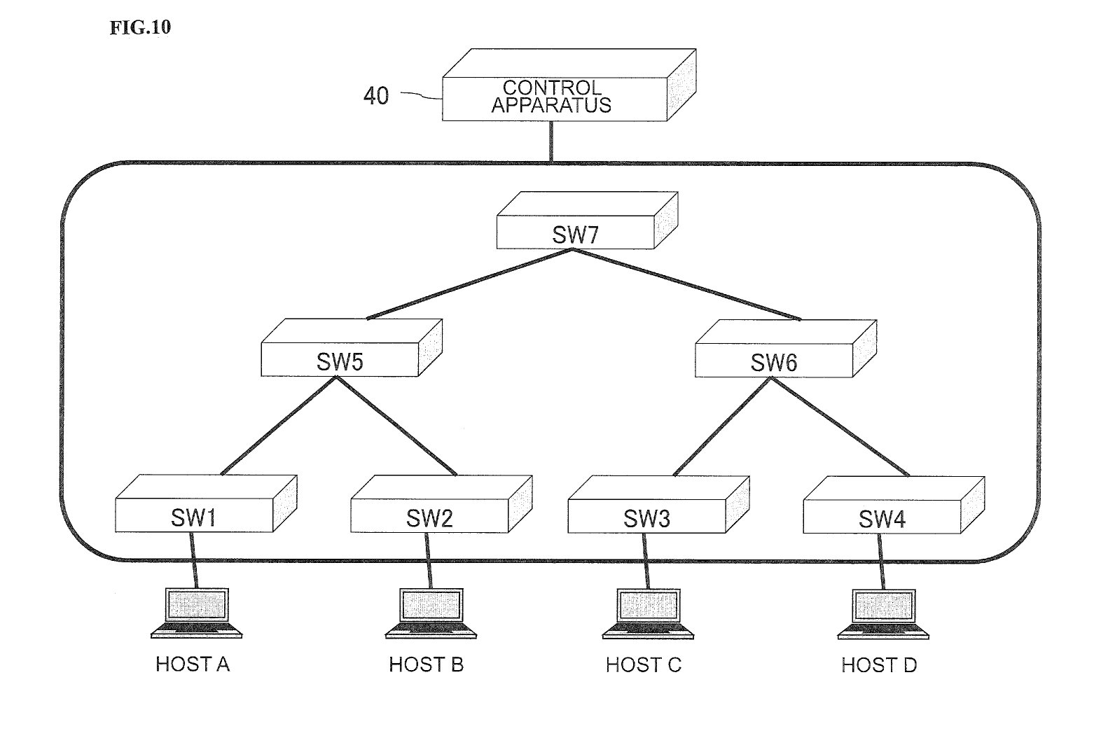

A communication system according to a third exemplary embodiment will be described with reference to the drawings. Although there is no hub switch in the communication system of the present exemplary embodiment, this communication system includes a switch having a particular feature or role such as a switch on which more traffic volume is concentrated than the other switches. FIG. 10 is a diagram showing an example of a configuration of a communication system according to the present exemplary embodiment.

With reference to FIG. 10, a control apparatus 40, seven switches SW1-SW7, and hosts A-D that communicate via the switches SW1-SW7 are illustrated. Although FIG. 10 is illustrated in a simplified manner, the control apparatus 40 is connected to all the switches SW1-SW7.

FIG. 10 illustrates one control apparatus 40, seven switches SW1-SW7, and four hosts A-D as an example. However, the number of these apparatuses included in the communication system is not limited to the mode shown in FIG. 10.

The control apparatus 40 may be the same as the control apparatus 20 in the first exemplary embodiment or the control apparatus 30 in the second exemplary embodiment. The switches SW1-SW7 may be the same as the switches in the first exemplary embodiment. Here, the control apparatus 40 is assumed to be the same as the control apparatus 30 in the second exemplary embodiment.

In the communication among hosts A-D, traffic volume is likely to concentrate on the switch SW7. Therefore, the number of flows via the switch SW7 is expected to be larger than that via the other switches.

Thus, the switch SW7 on which flows are concentrated is regarded as a gateway switch. And an identifier and second processing rules, on which a packet is forwarded to the gateway switch, are set in all switches SW1-SW7.

Here, a configuration of the control apparatus 40 is assumed to be the same as the configuration of the control apparatus 30 in the second exemplary embodiment. Then, the control apparatus 40 executes the following processing.

First, the topology management unit 22 of the control apparatus 40 (see FIG. 8) conducts search and selection of a gateway switch in the network. Traffic volume may be used for an evaluation criterion to select the gateway switch. The number of flows or the like may be also adopted as the evaluation criterion. Furthermore, the gateway switch may be selected based on other policies such as security, loading balance, and network operation.

The path tree and action calculation unit 28 calculates a path tree, in which the gateway switch is set as a root, based on the gateway switch as an origin selected by the topology management unit 22, and also calculates processing contents needed for each switch in a case where a packet is forwarded via the calculated path tree. The path tree and action calculation unit 28 may calculate a path tree using Dijkstra's Algorithm in which number of hops is used as a metric. The path tree and action calculation unit 28 may calculate a path tree by the other metrics and algorithms.

The identifier management unit 24 assigns a unique identifier to a path tree and processing contents according to the path tree. In this way, second processing rules that are set in each switch can be obtained. The second processing rules and the identifier are set in the switches SW1-SW7.

The control apparatus 40 executes the above-mentioned processing before a packet forwarding. In this case, packets can be forwarded from switches, in which the second processing rules are set, to the gateway switch SW7 using one identifier. Further, it is sufficient that one second processing rule is also set in each switch.

If the switch SW7, on which traffic volume is concentrated, is selected as a gateway switch, many packets can be forwarded to the switch SW7 selected as a gateway switch using one identifier. Therefore, according to the communication system of the present exemplary embodiment, the number of processing rules included in an array of processing rules contained in the packet can be reduced.

Further, according to the communication system of the present exemplary embodiment, in a case where a part of an array of processing rules is not included in the packet, the number of inquiries to the control apparatus 40 during forwarding can be reduced, too. Therefore, load of the control apparatus 40 can be reduced, and communication delay can be also reduced.

The exemplary embodiments and examples may include variations and modifications without departing the gist and scope of the present invention as disclosed herein and claimed as appended herewith, and furthermore based on the fundamental technical spirit. It should be noted that any combination and/or selection of the disclosed elements may fall within the claims of the present invention. That is, it should be noted that the present invention of course includes various variations and modifications that could be made by those skilled in the art according to the overall disclosures including claims and technical spirit.

### REFERENCE SIGNS LIST

11 control apparatus communication unit
12 flow table management unit
13 flow table
14 packet buffer
15 forwarding processing unit
20, 30, 40 control apparatus (controller)
21 flow entry DB
22 topology management unit
23 path and action calculation unit
24 identifier management unit
25 flow entry management unit
26 control message processing unit
27 switch communication unit
28 path tree and action calculation unit
121 processing rule setting information extraction unit
151 processing rule array processing unit
152 identifier extraction unit
153 processing rule extraction unit
154 table search unit
155 action execution unit
A-D host
SW, SW1-SW8 switch
x identifier

What is claimed is:

1. A communication system, comprising:
a first switch that refers to a first processing rule included in a packet and processes the packet in accordance with the first processing rule;
a second switch that includes a table associating and storing an identifier and a second processing rule for a packet, refers to an identifier included in a packet, and processes the packet in accordance with a second processing rule associated with the identifier; and
a control apparatus that stores the first processing rule and the identifier in a packet, associates and stores, in the table of the second switch, the identifier and the second processing rule.

2. The communication system according to claim 1, wherein
the first switch includes a table that associates a pointer and the first processing rule, refers to a pointer included in a packet, and processes the packet in accordance with the first processing rule associated with the pointer; and
the control apparatus stores the pointer and the identifier in a packet, associates and stores, in the table of the first switch, the pointer and the first processing rule

3. The communication system according to claim 1, wherein
the control apparatus stores the first processing rule and the identifier in a header field of a packet.

4. The communication system according to claim 1, wherein
the first switch refers to a count value included in a packet and, in accordance with the count value, refers to the first processing rule or the pointer included in the packet; and
the second switch refers to a count value included in a packet and, in accordance with the count value, refers to the identifier included in the packet

5. The communication system according to claim 4, wherein
the first switch, after updating the count value, processes the packet in accordance with the first processing rule; and
the second switch, after updating the count value, processes the packet in accordance with the second processing rule if the second switch is the last switch that refers to the identifier, and otherwise, processes the packet in accordance with the second processing rule without updating the count value.

6. The communication system according to claim 1, wherein
the second switch deletes the identifier included in the packet or describes in the packet that the identifier has been already referred to if the second switch is the last switch that refers to the identifier.

7. The communication system according to claim 1, further comprising
a plurality of the second switches, wherein
the control apparatus determines a path tree for the plurality of second switches and stores packet-forwarding based on the determined path tree as the second processing rule in each table of the plurality of second switches.

8. The communication system according to claim 7, wherein
the control apparatus selects a switch corresponding to a root node of the path tree among the plurality of second switches in accordance with order of connection points for the switch, traffic volume of packets processed by the switch, or number of flows processed by the switch.

9. A communication method, comprising:
by a first switch, referring to a first processing rule included in a packet and processing the packet in accordance with the first processing rule;
by a second switch that includes a table associating and storing an identifier and a second processing rule for a packet, referring to an identifier included in a packet and processing the packet in accordance with a second processing rule associated with the identifier;
by a control apparatus, storing the first processing rule and the identifier in a packet; and
by the control apparatus, associating and storing, in the table of said second switch, the identifier and the second processing rule.

10. The communication method according to claim 9, wherein
the first switch includes a table that associates a pointer and the first processing rule, and
the method further comprising:
by the first switch, referring to a pointer included in a packet and processing the packet in accordance with the first processing rule associated with the pointer;
by the control apparatus, storing the pointer and the identifier in a packet; and
by the control apparatus, associating and storing, in the table of the first switch, the pointer and the first processing rule.

11. The communication method according to claim 9, wherein
the control apparatus stores the first processing rule and the identifier in a header field of a packet.

12. The communication method according to claim 9, further comprising:
by the first switch, referring to a count value included in a packet and, in accordance with the count value, referring to the first processing rule or the pointer included in the packet; and
by the second switch, referring to a count value included in a packet and, in accordance with the count value, referring to the identifier included in the packet.

13. The communication method according to claim 12, further comprising:
by the first switch, after updating the count value, processing the packet in accordance with the first processing rule; and
by the second switch, after updating the count value, processing the packet in accordance with the second processing rule if the second switch is the last switch that refers to the identifier, and otherwise, processing the packet in accordance with the second processing rule without updating the count value.

14. The communication method according to claim 9, further comprising:
by the second switch, deleting the identifier included in the packet or describing in the packet that the identifier has been already referred to if the second switch is the last switch that refers to the identifier.

15. The communication method according to claim 9, further comprising:
by the control apparatus, determining a path tree for a plurality of the second switches; and
storing packet-forwarding based on the determined path tree as the second processing rule in each table of the plurality of second switches.

16. The communication system according to claim 2, wherein
the control apparatus stores the first processing rule or the pointer, and the identifier in a header field of a packet.

17. The communication method according to claim 10, wherein
the control apparatus stores the first processing rule or the pointer, and the identifier in a header field of a packet.

18. A control apparatus controlling a communication that includes at least a first switch and a second switch, wherein
the first switch refers to a first processing rule included in a packet and processes the packet in accordance with the first processing rule;
the second switch includes a table associating and storing an identifier and a second processing rule for a packet, refers to an identifier included in a packet, and processes the packet in accordance with a second processing rule associated with the identifier; and
the control apparatus stores the first processing rule and the identifier in a packet, associates and stores, in the table of the second switch, the identifier and the second processing rule.

19. The control apparatus according to claim 18, wherein
the first switch includes a table that associates a pointer and the first processing rule, refers to a pointer included in a packet, and processes the packet in accordance with the first processing rule associated with the pointer; and
the control apparatus stores the pointer and the identifier in a packet, associates and stores, in the table of the first switch, the pointer and the first processing rule.

20. The control apparatus according to claim 18, wherein
the control apparatus stores the first processing rule and the identifier in a header field of a packet.
